(19) United States
(12) Patent Application Publication
(10) Pub. No.: US 2002/0038225 A1
(43) Pub. Date: Mar. 28, 2002

(54) Method and system for matching donations

(76) Inventors: Benjamin R. Klasky, Menlo Park, CA (US); Ann K. Goggins, San Francisco, CA (US); Charles Marshall, Atherton, CA (US)

Correspondence Address: Robert E. Krebs, BURNS, DOANE, SWECKER & MATHIS, L.L.P., P.O. Box 1404, Alexandria, VA, 22313-1404, US

(21) Appl. No.: 09/966,747

(22) Filed: Sep. 27, 2001

Related U.S. Application Data
(60) Provisional application No. 60/236,401, filed on Sep. 28, 2000.

(51) Int. Cl. G06F 17/60

(52) U.S. Cl. 705/1; 705/35

(57) ABSTRACT

A method and system for soliciting online donations is disclosed. The method comprises defining the terms of a challenge. Next, an invitation to donate is generated that includes the terms of the challenge. Typically, the terms of the challenge are a matching donation such that the challenger will match donations to a prescribed amount. Finally, the invitation to donate is sent to at least one invitee with a computer connected to a network of computers. The invitee can reply to the challenge by making a donation with his or her computer. The method is performed by a web-based donation application that can be accessed through the web browser of a challenger or invitee.

### CROSS REFERENCE TO RELATED APPLICATIONS

The present application claims priority to U.S. Provisional Patent Application No. 60/236,401 filed Sep. 28, 2000 entitled “Method and System for Matching Donations”, the contents of which are incorporated by reference herein.

### BACKGROUND OF THE INVENTION

1. Field of the Invention

The present invention generally relates to a method of matching donations utilizing the Internet.

2. Status of the Related Art

Challenge grants are donation schemes whereby an individual (“donor” or “champion”) will challenge friends, peers, relatives and/or colleagues (“invitees” or “referrals”) to make a charitable donation to the donor's favorite nonprofit organization(s). The donor issues a challenge (matching) grant based on the donor's defined criteria. In this type of system, the donor can limit the amount of the gift that he or she will give based upon the amount donated by friends and/or families. For example, the donor can specify that he or she will match dollar for dollar amounts given by his or her friends or relatives up to a maximum amount. In this respect, the donor can limit the amount of his or her matching gift.

Typical challenge grants are implemented using traditional fund-raising campaigns. In such campaigns, solicitation for the challenge grant is delivered either via mail or telephone to the invitees. As such, the traditional challenge grant campaigns have relied heavily on one-to-one personal meetings. This type of approach is both time-consuming and expensive with results that are often abysmal. The success of these campaigns is reliant upon getting the information to the invitees who wish to make a donation.

Recently, fund-raising for nonprofit organizations has moved to the Internet. Nonprofit organizations, as well as fund-raising organizations, have created Web pages for soliciting donations. The amount and type of donations can be posted and tracked. Additionally, the organizations will email prospective donors to solicit gifts and spread their mission and beliefs instantly via the Internet. However, donors are not involved in choosing the recipients of the email. As such, donors are not actively involved in the solicitation of gifts using the Internet. Additionally, there is no system in place for challenging invitees for matching the donor's grant.

Additionally, organizations soliciting donations over the Internet have not been able to receive stock certificates in lieu of cash. The organizations have been limited to cash donations for online fund-raising due to the complexity of stock transfers. As such, the online fund-raising ability of these organizations has been greatly decreased.

The present invention addresses the above-mentioned deficiencies in prior art donation schemes by providing a system and method whereby challenge grants are issued using the power of the Internet. In this respect, a donor has the ability to use the present invention to issue challenges to selected invitees by using the Internet. The present invention thereby allows a donor the opportunity to instantly access donation results and track campaigns in order to target potential invitees. Furthermore, the present invention allows online stock transfers which greatly enhances fund-raising opportunities.

### BRIEF SUMMARY OF THE INVENTION

The present invention is a system and method of issuing challenge grants using the Internet. Specifically, the system is an online tool by which a donor issues invitations to invitees to make a charitable donation to the donor's favorite nonprofit organization. The online tool allows a donor to issue a challenge grant based on the donor's pre-defined criteria (a donor defined algorithm) such as matching donations dollar to dollar, up to a donor-specified amount for each invitee; matching donations based on a donor-specified percentage of each dollar, up to a donor-specified amount for each invitee; matching on a tiered basis, whereby donor matches varying amounts depending on how much each invitee donates; or matching a bonus amount based on a high level of participation from a collective group of invitees.

The present invention also allows invitees to respond to a donor's challenge and donate to a selected charity in a variety of ways such as transferring stock to the charity via an online stock transfer system, writing a check and mailing the check to the charity, using online credit card payment systems, or raising money from their peers by, in turn, challenging their peers to give through the online system. In this respect, the present invention provides an online tool for invitees to make donations and/or challenge others to make donations to their favorite nonprofit organization.

The present invention facilitates online campaigns, and encourages a “viral” approach to securing funds for nonprofit organizations. By allowing a donor and potential donors the opportunity to track campaigns, those who have not yet given may be inspired to contribute. The mode, which would be entirely online, allows for groups of individuals to: (a) designate how various “levers” will be used to determine charities; (b) vote online at any time; and (c) view results of votes at any time. Votes are tallied and processed in real-time, making it easy to view results. Once recipient charities have been selected, individuals can remit donations online, either through stock, check or credit card.

By posting campaigns online and offering the opportunity to track campaign processes online, the mechanism will ideally encourage those who have not yet donated to do so. The present invention allows individuals to play a more active role in the charitable giving process, engaging users to have a direct and immediate impact on the decision-making process.

### BRIEF DESCRIPTION OF THE DRAWINGS

These, as well as other features of the present invention, will become more apparent upon reference to the drawings wherein:

FIG. 1 is a diagram showing the operation of the present invention on a computer system.

FIGS. 2-5 are flowcharts showing how a donation is matched using the present invention.

FIGS. 6 is an email message of a challenge.

FIG. 7 is a screen shot of a donation screen.

FIGS. 8-14 are flowcharts showing how stock certificates are donated in accordance with the present invention.

FIG. 15 is a screen shot of a challenge web page.

FIG. 16 is an email showing the status of a challenge.

### DETAILED DESCRIPTION OF THE INVENTION

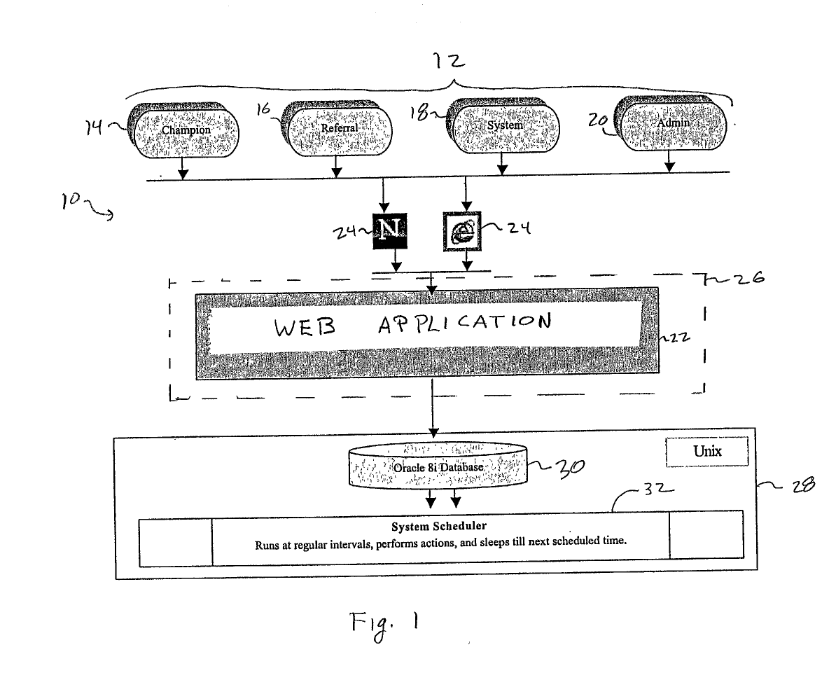

Referring now to the drawings wherein the showings are for purposes of illustrating a preferred embodiment of the present invention only, and not for purposes of limiting the same, FIG. 1 illustrates an electronic philanthropic system 10 for providing and matching donations, as well as providing stock donations to organizations. The philanthropic system 10 is a Web-based online fund-raising tool that can assist charitable organizations in leveraging the Internet for a good cause. The system 10 can be divided into entities 12 that can be persons or processes that interact directly in the philanthropic system 10. The entities 12 can initiate campaigns (champions 14), donate to charitable organizations (referrals 16), perform operations (system 18), and maintain overall information (admin 20). Each of the entities accesses a web application 22 through an appropriate web browser 24 which supports JavaScript. The web application 22 will be installed on a web server 26 which serves HTTP requests. The web application 22 communicates with database computer 28 in order to access and store information. The database computer 28 is installed with a relational database management system 30 such as Oracle 8i for storing information. The database management system 30 additionally communicates with a system scheduler application 32 which performs actions at regularly scheduled intervals.

As previously mentioned, the champion 14 is an individual or a group that can initiate the donation process by providing charity and personal contact information, along with donation information to the philanthropic system 10. The champion 14 can perform the following actions by accessing the web application 22 through his or her web browser 24:

1) Provide personal contact information;

2) Select an existing charity organization;

3) Request setting up a new charity organization;

4) Refer friends as prospective donors;

5) Create a challenge;

6) Make a donation;

7) Indicate the mode of transaction for donation;

8) Send reminders to (a) whole group, (b) referrals who have not taken any action yet, and (c) referrals who have made a donation; and

9) Send thank you notes with IRS receipt via email to referrals who have donated.

A referral 16 is a prospective donor who was referred to the web application 22 via an email sent by a champion 14. As will be further explained below, the email will be a challenge to the referral 16 by the champion 14 to donate to the same organization for which the champion donated. If the referral 16 donates to the same organization as the champion 14 before an expiration date of the challenge, then the champion 14 will have to match the donation as per the criteria created as part of their challenge. A referral 16 can perform the following actions with the web application 22:

1) Provide contact information;

2) Make a donation as part of a champion's challenge by selecting a link provided in the email from the champion; and

3) Be champions themselves by creating challenges for the same and/or a different organization. When a referral 16 becomes a champion 14, only their individual donation will be considered towards the challenge of the champion 14 who referred them in the first place.

The system 18 is that part of the web application 22 which is taking actions at prescribed times automatically or interactively when champions 14, referrals 16, and/or admin 20 are logged on through a browser 24 sending requests and responses. The system 18 builds HTML pages with JavaScript for client-side validation dynamically to be sent back to the client browser. The responsibilities of the system 18 include:

1) Publish the web application 22 web site;

2) Verify users;

3) Store information on donors;

4) Create challenges for champions 14 with expiration dates;

5) Send emails to champions 14, referrals 16 and admin 20;

6) Calculate the final donation amount due for a champion 14 after expiry of challenge;

7) Process credit card transactions online through an approved vendor;

8) Store information on new charities requested for setup; and

9) Report weekly status to champions 14 and admin 20. This can be manually triggered by the admin 20 such that the status reports can be issued more than once a week such as for challenges with more aggressive timelines.

The admin 20 is the person who maintains the overall information of the philanthropic system 10. The admin 20 can access the web application 22 for running reports through a password protected login to the system from his or her browser 24. The admin 20 would:

1) Verify and create new organizations that can be given donations;

2) Receive a donation transaction report from the database 30; and

3) Initiate weekly status report emails to champions 14.

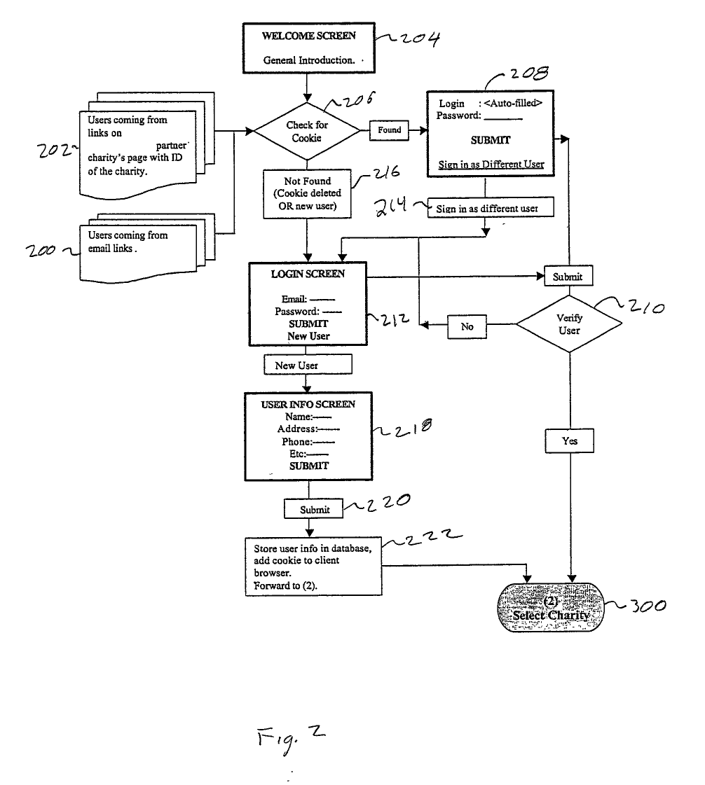

As previously mentioned, entities 12 will access the web application 22 through web browser 24. The entity must log into the philanthropic system 10 in order to gain access to the web application 22. Referring to FIG. 2, the entity 12 can access the philanthropic system 10 through either an email link 200 or a link from a partner's page 202. Alternatively, the entity 12 can access the philanthropic system 10 by typing in the URL for the system 10 in his or her browser 24, as seen in step 204. In step 206, the web application 22 will check the browser 24 of the entity 12 for a cookie which signifies that the entity 12 is a return user. If a cookie is found, then a login screen with the username of the entity 12 is displayed in step 208. The entity 12 can sign in as a different user in step 214 or enter his or her password which is then submitted and verified in step 210. If the entity 12 is a verified user, then the entity 12 can proceed to select a charity in step 300. However, if the entity 12 is not verified in step 201, then the entity 12 is directed toward a login screen in step 212 where the user can login with a different username and password. Additionally, the entity 12 can login using step 212 if the entity 12 is logging in as a different user or a cookie is not found (step 216).

Once the entity 12 enters the login screen in step 212, the entity 12 will access a new user info screen in step 218 wherein the entity will enter personal contact information such as his or her name, address, phone number, etc. . . . The new user information will be submitted in step 220 and stored in database 30. Additionally, a cookie may be added to the browser 24 of the entity 12 to signify that the entity 12 is a returning user the next time the entity 12 accesses the philanthropic system 10. Once the information of the entity 12 has been stored in database 30, the entity 12 can select a charity in step 300.

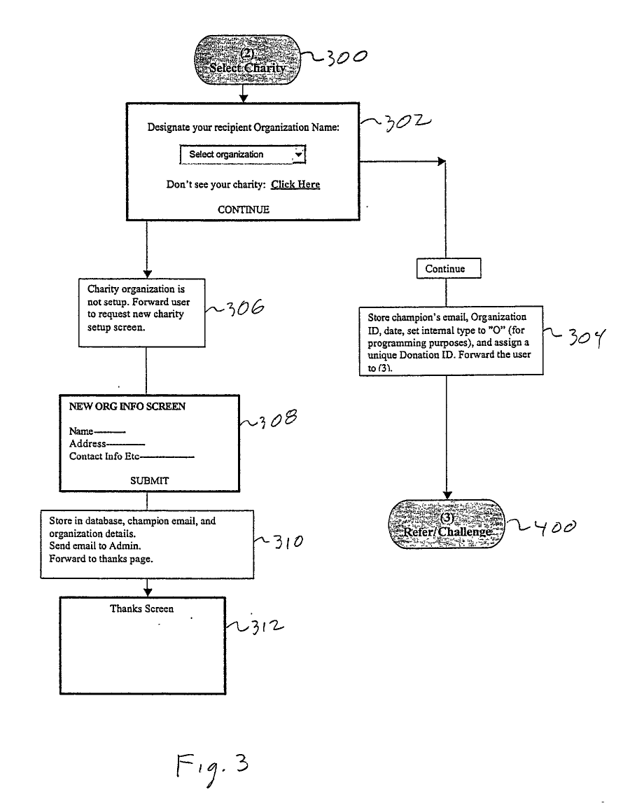

Referring to FIG. 3, the entity 12 has the opportunity to select a charity (i.e., organization) as a recipient for a donation. The entity 12 will first have the opportunity to select a charity in step 302. The entity 12 can choose from a list of organizations or can add his or her own organization. If the entity 12 selects an organization from a pull-down list, then the web application 22 will continue and store information about the entity 12 in step 304. Once the information has been stored, then the entity 12 can refer and challenge other entities 12 in step 400. However, if the organization is not listed, the entity 12 can enter the information manually. The entity 12 will be forwarded to a setup screen in step 306. In step 308, the entity 12 will enter the name, address, and contact information of the organization. As seen in step 310, the information will be stored in the database 30 and an email will be sent to the entity 12 informing him or her that the organization will be entered into the database. Additionally, an email will be sent to the admin 20 informing him that a new organization should be entered. A new organization will not be entered until the admin 20 has the opportunity to verify the charitable status of the organization in order to prevent fraud. Finally, the entity 12 is directed to a thank you page in step 312 wherein the entity 12 is informed about the rules and procedures of the philanthropic system 10.

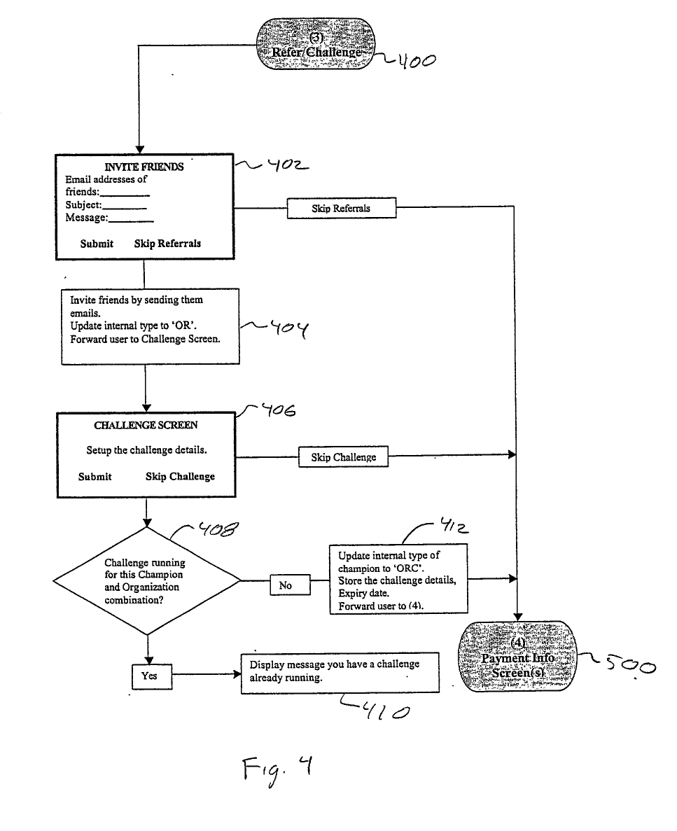

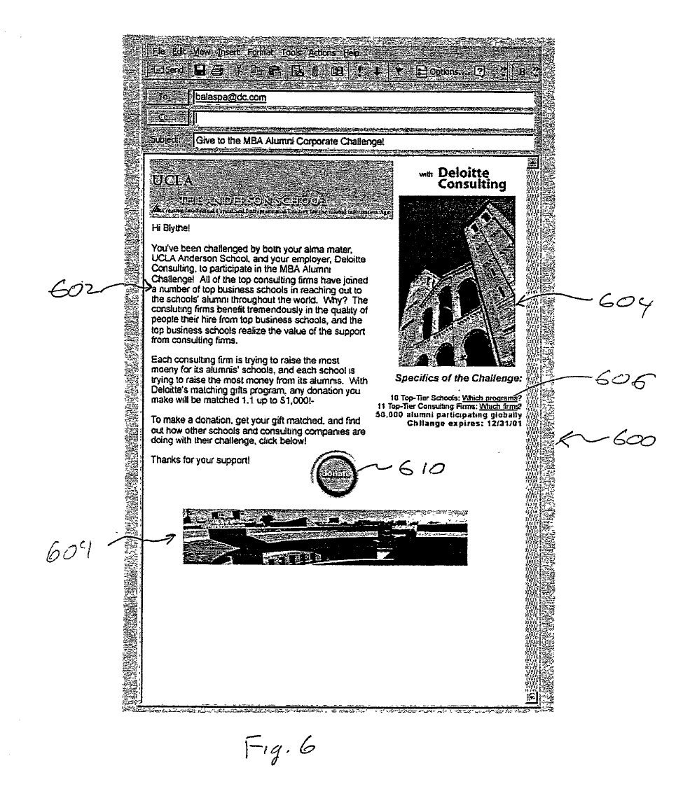

Once the entity 12 has decided the organization, then the entity 12 can refer others to donate. Referring to FIG. 4, after the entity 12 has selected his or her organization, the entity 12 will be presented with an invite friends screen in step 402. The invite friends screen will allow the entity 12 to enter the names and email addresses of the friends (i.e. referrals 16) that the entity 12 wishes to send challenges. Additionally, at this time, the entity 12 can enter the message that will be displayed in the email message. Referring to FIG. 6, a sample challenge email message 600 is shown. The challenge email message 600 will contain a body portion 602 which will be a message challenging the referral 16 to make a donation. The message 600 can also contain graphics images 604 which highlight the charitable organizations. Information links 606 provide links to web pages that provide additional information about the charitable organization. Finally, the challenge email message 600 will contain a donate link 610 which is the URL of the philanthropic system 10. In this respect, if the referral 16 wishes to donate, then by selecting the donate link 610, the web browser 24 of the referral 16 will automatically be opened to the web application 22 of the philanthropic system 10. The referral 16 can then proceed with step 204 to make a donation. The challenge message 600 is automatically created by the philanthropic system 10 according to the rules of the champion 14.

Eventhough the philanthropic system 10 is being described as being able to solicit donations for a charitable organization, it can also be used in the for-profit arena. For example, a venture capitalist could use the system 10 to challenge others in raising funds for a favored start-up. The system 10 could be used for soliciting dollars, time, goods, etc. in the for-profit arena by providing a network avenue.

If the entity 12 does not wish to make a challenge at this time, he or she is given the option to skip sending out challenge emails and to proceed directly to the payment info screen in step 500 to make a donation. Otherwise, the names and addresses of referrals 16 will be stored in the database 30 in step 404 and the entity 12 will be forwarded to a challenge screen in step 404. As seen in step 406, the entity 12 can then enter the details of the challenge and submit them to the database 30, or skip the challenge and be forwarded to the payment info screen in step 500. After the entity 12 has entered the challenge information, the system 10 will determine if the entity 12 (i.e., a champion 14 at this point because a challenge has been issued) is already running a challenge for this organization in step 408. If so, then the system 10 will display in step 410 that a challenge is already running. If the combination of the champion 14 and the charitable organization is not found, then in step 412, the specifics of the challenge will be stored in database 30 and the champion 14 will be referred to payment info screen 500. The champion 14 will enter details about the challenge such as the expiration date of the challenge and the matching amount that the champion 14 is willing to donate.

The philanthropic system 10 can be utilized to match donations other than just money. It will be recognized that the system 10 can be adapted to match any type of donation. For instance, a champion 14 can challenge referrals 16 to donate goods and services which will be matched by the champion 14. Each referral 16 could volunteer his or her time to the charitable organization which would then be matched with either time or money by the champion 14. The system 10 could be set-up to provide reports which track volunteer efforts of the referrals 16. Alternatively, the challenge can be configured to match donations of goods which the champion 14 will match. Accordingly, the system 10 is adaptable to provide a challenge of any type.

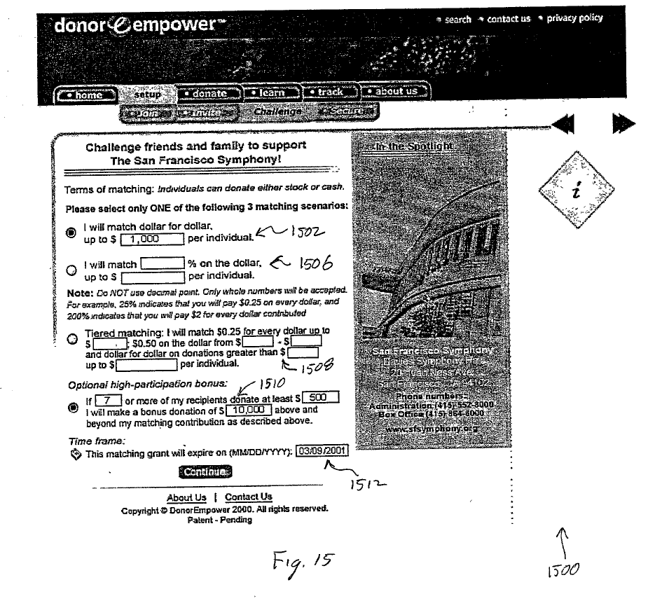

Referring to FIG. 15, a sample challenge web page 1500 is shown where the champion 14 can enter the details of his or her challenge. As seen by the challenge web page 1500, the champion 14 can match a dollar to dollar amount up to a prescribed amount in section 1502. Alternatively, the champion 14 can match a percentage of the dollar amount to be donated in section 1506. Furthermore, tiered matching is possible in section 1508 where the champion 14 can match funds at different increments depending upon the amount donated by the referral 16. The champion 14 can also include a bonus program in his or her challenge in section 1510. If a certain number of referrals donate a prescribed amount, then the champion 14 will provide a bonus to the organization. Finally, with the challenge page 1500, the champion 14 can determine the expiration date of the challenge in section 1512. It will be recognized that there are many different types of challenges that can be created and the system 10 can be programmed accordingly so that challenge page 15 can display them all.

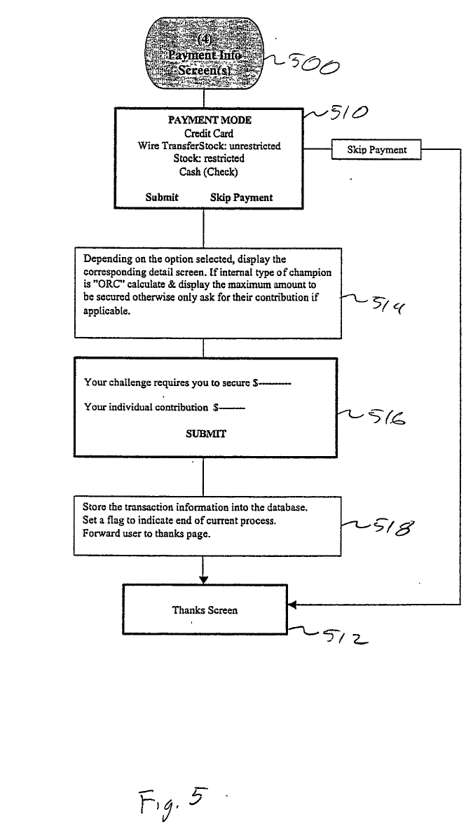

Referring to FIG. 5, the entity 12 is presented with a payment mode screen in step 510 upon being referred to payment info screen 500. At this point, the entity 12 can submit a donation to the organization previously chosen or skip making a donation. If the entity 12 wishes to skip making a donation, then he or she will be referred to a thank you screen in step 512. However, if the entity 12 wishes to continue, the entity 12 will submit his or her payment information such as the type of payment that he or she will use to match the donations which are received if the entity 12 is a champion 14. For instance, the champion 14 can indicate that he or she can match the donations by credit card, stock transfer or with cash or check. Additionally, the payment mode screen in step 510 can be used by a referral 16 to make a donation to the charity organization. The referral 16 can make a donation via either a stock transfer, credit card payment or cash payment. Once the payment information has been submitted in step 510, the information will be entered into the database 30 in step 514. Depending upon whether the entity 12 is a champion 14 or a referral 16, the system 10 will display the corresponding screen. For instance, if the entity 12 is a champion 14, then the system 10 will calculate the maximum amount that the champion 14 will need to donate in order to match the donations of the referrals 16. The matching amount will be displayed in step 516. However if the entity 12 is a referral 16, then the system 10 will display a screen asking for the contribution amount that the referral 16 wishes to donate. The referral 16 will submit this information in step 516 and it will be recorded by the system 10 in step 518. Once this information is recorded in the database 30, the entity 12 will be directed to a thank you screen in step 512 and the process will be completed.

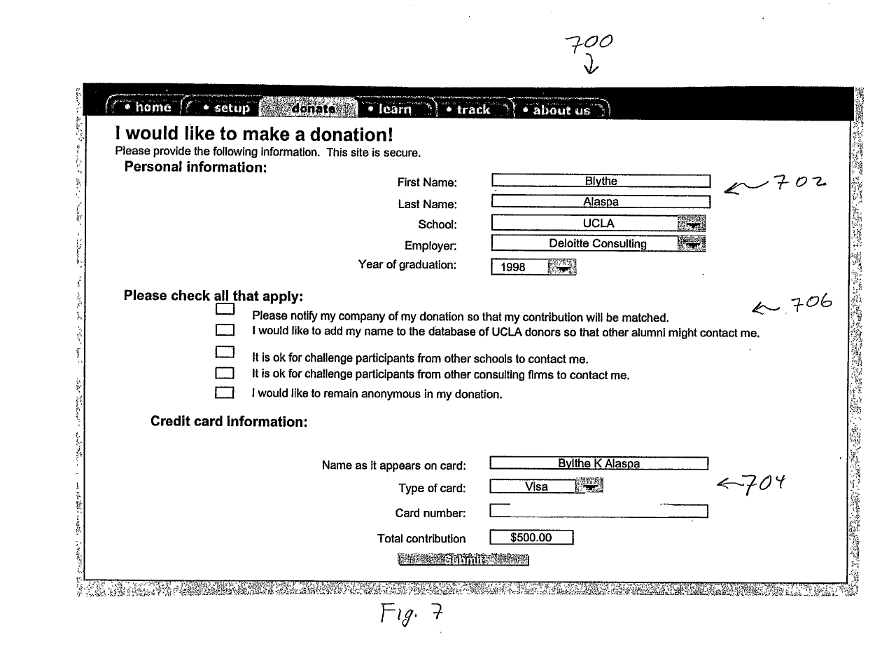

Referring to FIG. 7, a sample donation web page 700 is shown. The donation web page 700 is generated by the web application 22 and allows the referral 16 to make a donation. The web page 700 includes a personal information section 702 which allows the referral 16 to enter his or her personal information. The web page 700 also includes a payment information section 704 where the method of payment can be chosen and the amount to be donated. In order to allow other information about the donation and the referral 16 to be collected, the web page 700 further includes an inquiry section 706 wherein the referral 16 can answer questions that the champion 14 or the charitable organization might want answered. For instance, the referral 16 might be asked whether he or she is willing to be contacted about other challenges and/or whether he or she wishes to remain anonymous.

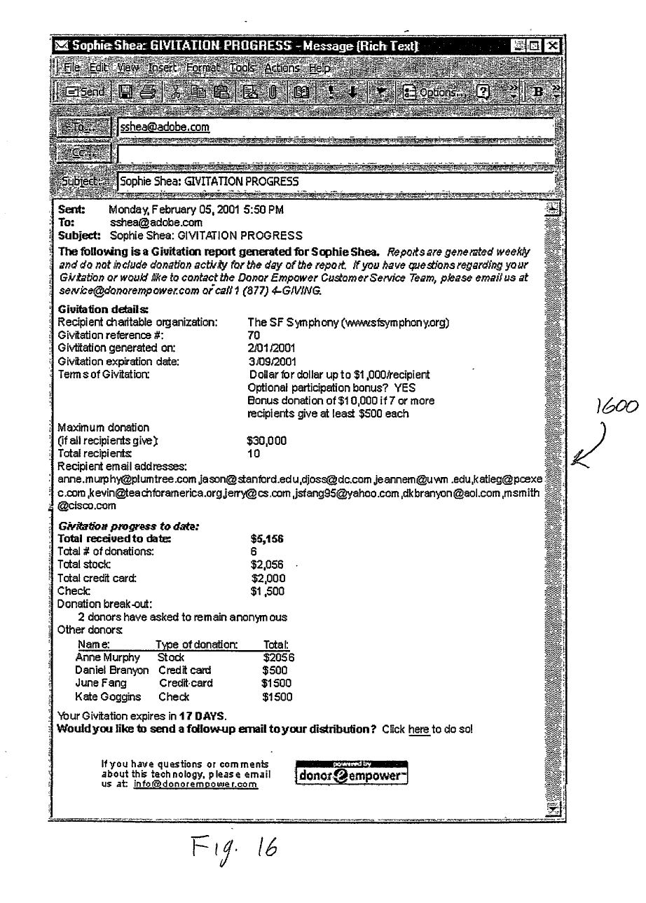

In addition to the foregoing, the philanthropic system 10 is also capable of creating informational web pages and sending emails which track the progress of a specific challenge. Once the entity 12 logs into the system 10, as shown in FIG. 2, the entity 12 can access information about challenges in progress. For instance, a champion 14 can see which referrals 16 have donated and the amount of donation. Furthermore, a referral 16 could view the progress of a challenge before deciding to donate. The web application 22 is capable of generating the informational web pages which are viewable on the browser 24 of the entity 12. The informational web pages would provide online, dynamic, real-time tracking functionality. The informational web pages would access information contained within database 30 to generate real-time, viewable reports that are accessible by the champion 14 to monitor and track the progress of his or her challenge. Furthermore, referring to FIG. 16, an update email message 1600 may be sent to champions 14 which update the progress of their challenge. The update email message 1600 may include information such as the terms of the challenge, the charitable organization, the total number of donations, the amount donated, the types of donations, and the names of the donors. It is also possible with the system 10 to customize the update message as desired by the champion 14.

The philanthropic system 10 is ideally suited for providing multi-tier challenges wherein a referral 16 will challenge others to donate to the same organization. In turn, other referrals 16 can challenge their friends thereby creating a vast network of referrals 16 which have the opportunity to donate. In the corporate setting (where a corporation is the champion 14), the ability to receive donations for the desired charitable organization is greatly enhanced by the multi-tier nature of the philanthropic system 10.

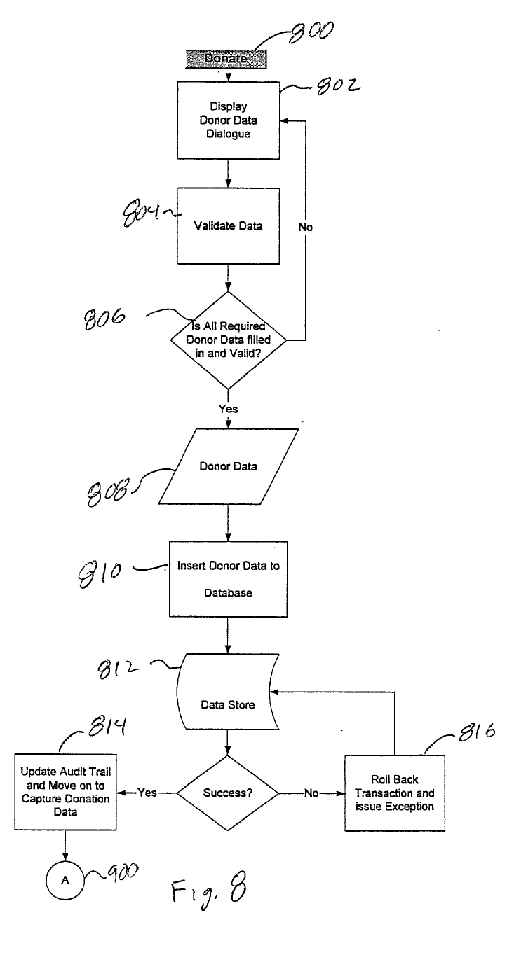

As previously discussed above, a referral 16 and a champion 14 can donate and match donations through the transfer of stock. The philanthropic system 10 allows a method for a person to simply and easily perform an electronic stock transfer to a charitable organization. The web application 22 and database 30 are utilized to perform the transaction. Referring back to FIG. 5, the transaction begins when the entity 12 decides to donate stock in step 510. At that point, the web application 22 will direct the entity 12 to donate step 800 shown in FIG. 8. The system 10 will display a donor data dialogue box in step 802 where the entity 12 can enter information about himself or herself which will be needed to transfer the stock. In step 804, the donor information is validated, and in step 806, it is determined whether all of the required data has been filled in and is valid. If the information is not filled in or not correct, then the process proceeds back to step 802. However, if the correct information has been entered, then the process proceeds to step 808 where the data is processed and step 810 where the data is stored in database 30. In step 812, the data is stored in database 30 and if successful, then the process continues to step 814 where an audit trail is updated and the process continues to step 900 where donation data will be captured. If the data is not successfully stored in step 812, then the transaction is rolled back and an exception is issued in step 816. The process returns to step 812 where the data is stored in database 30 again.

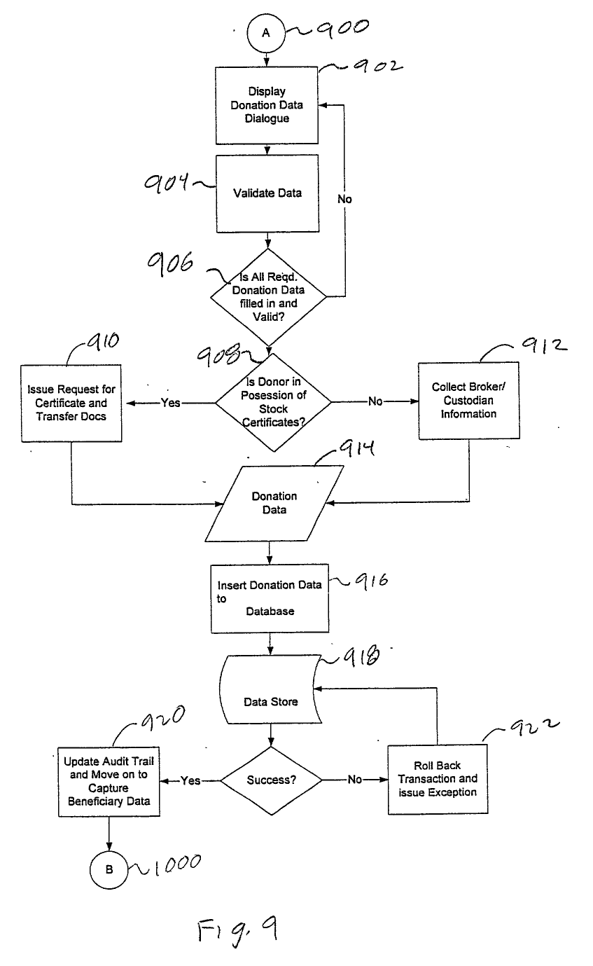

Referring to FIG. 9, the process of capturing donation information is shown. The process begins with step 902 wherein a donation data dialogue box is displayed. The entity 12 will enter information about the stock transfer (i.e., type of stock, amount, possession) in step 902. The information will be validated in step 904 and will be checked to see if all the required information has been entered in step 906. If the required information has not been entered, then the process will return to step 902 so that the donation data can be updated.

If the information is correct and valid, then in step 908, it is determined whether the donor of the stock is in possession of the stock certificates. If the donor has possession, then the process continues to step 910 where a request is issued for certificate and transfer documents. If the donor is not in possession of the stock certificates, then the system 10 will inquire the broker/custodian information for the stock certificates from the donor in step 912. After receiving broker/custodian information or issuing a transfer document request, the process continues to step 914 where the donation information is stored. Next, the donation information is inserted into the database 30 in step 916 and stored in step 918. If the data is successfully stored in step 918, then the audit trail is updated and the process proceeds to capture beneficiary data in step 920. If the donation data is not successfully stored, then the process continues to step 922 where the transaction is rolled back and the data stored again in step 918.

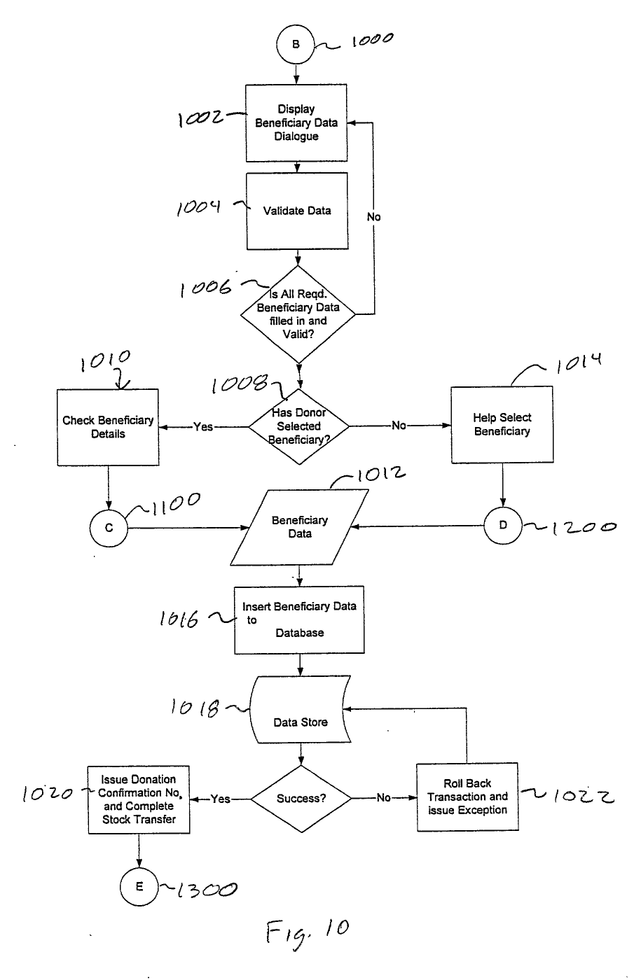

Referring to FIG. 10, the beneficiary data is captured by first displaying a beneficiary data dialogue box in step 1002. The data is validated in step 1004 and it is determined whether all of the required information has been collected in step 1006. If all of the data has not been collected, then the process returns to step 1002 for proper entry. Once the beneficiary data has been completely entered, it is determined in step 1008 whether a beneficiary has been selected by the entity 12 donating the stock certificates. Typically, if the donation is the result of a challenge, then the beneficiary will be the organization chosen by the champion 14. However, the philanthropic system 10 can be used to facilitate a stock transfer to a charitable organization without a challenge being issued. In that instance, the person donating the stock must decide on a beneficiary.

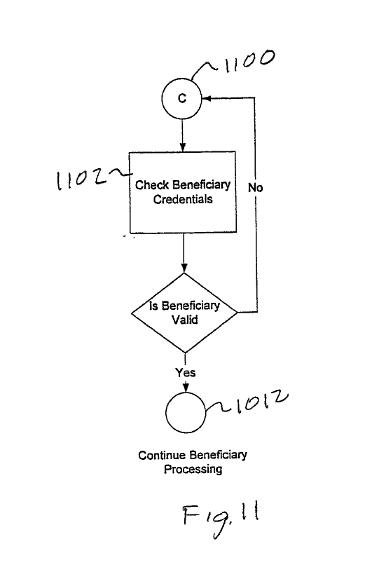

If a beneficiary has been chosen, then the process continues to step 1010 where the details of the beneficiary are checked. After completing a check of the details, the process continues to step 1100 where the credentials of the beneficiary are checked. Referring to FIG. 11, the beneficiary is checked to determine whether it can receive stock and can be a valid beneficiary in step 1102. If the beneficiary is valid, then the process returns to step 1012. However, if the beneficiary is not valid, then the credentials of the beneficiary are checked again in step 1102. Once it has been determined that the beneficiary is valid, then the process continues to step 1012 where the beneficiary data is combined.

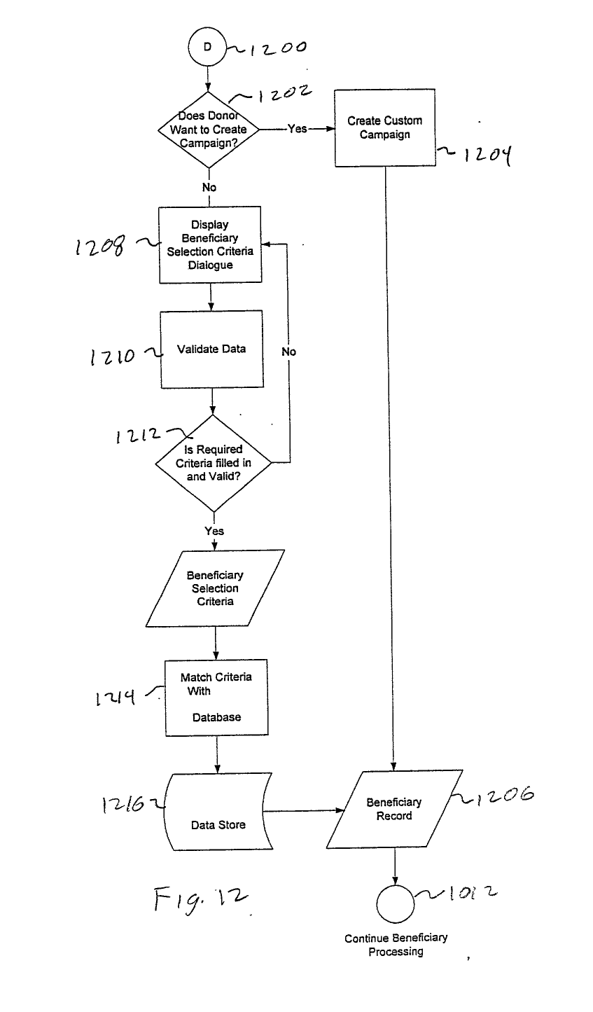

If the donor has not selected a beneficiary in step 1008, then the process continues to step 1014 where the donor is given help to select a beneficiary. Specifically, the process proceeds to step 1200 where, as shown in FIG. 12, the donor is asked whether he or she wants to create a challenge campaign in step 1202. If the donor wishes to create a custom campaign, then the process proceeds to step 1204 where the campaign is created as a challenge, as previously mentioned. Once the campaign has been created, then the beneficiary is recorded in step 1206 and beneficiary processing is continued and returned to step 1012. If the donor doesn't wish to create a campaign, then the process continues to step 1208 where beneficiary selection criteria is displayed. The entity 12 will have the opportunity to enter data about the selection criteria of the beneficiary which is validated in step 1210. In step 1212, the criteria is checked to see if it has all been filled in and is valid. If it is not valid or not filled in completely, then the process returns to step 1208. However, if the data is valid, then the criteria is matched with beneficiaries contained within the database 30. For instance, if the donor wishes to donate stock to organizations which benefit animals, then the SPCA might be a beneficiary that is matched in step 1214. Once the beneficiary has been matched to the criteria, then the beneficiary data is stored in step 1216 and recorded in step 1206. The process then continues to step 1012.

Referring back to FIG. 10, once the beneficiary data has been determined in step 1012, then the data is inserted into the database 30 in step 1016. Next, the data is stored in step 1018. If the data is successfully stored, then the process continues to step 1020 where a donation confirmation number is issued and the stock transfer is completed by proceeding to step 1300. However, if the data is not successfully stored, then the process continues to step 1022 where the transaction is rolled back and the data store is attempted again.

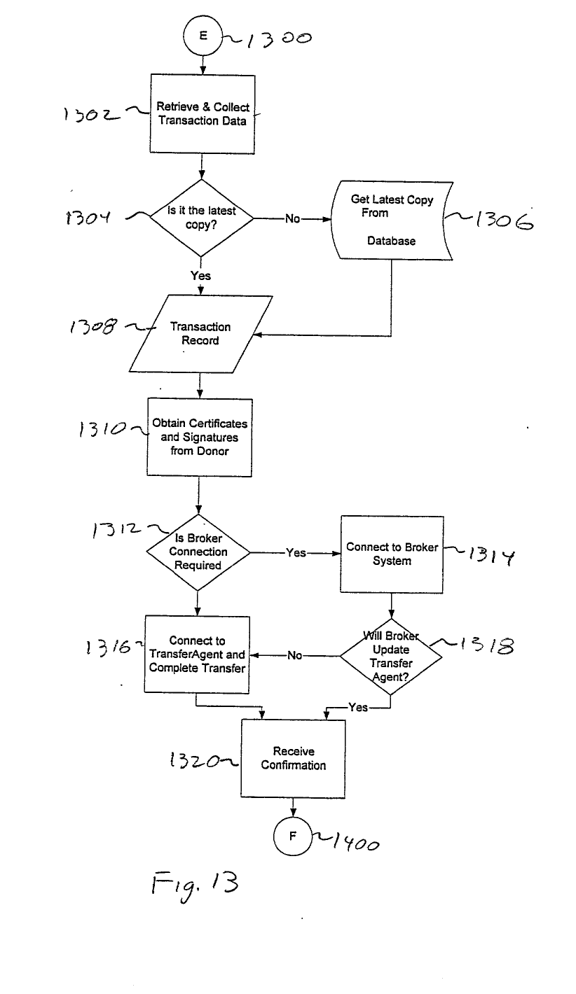

Referring to FIG. 13, the stock transfer is completed in step 1302 by first retrieving and collecting the transaction data from the database 30. Next, in step 1304, it is determined whether the latest copy of the transaction data has been retrieved and collected. If it is not the latest copy, then the latest copy is retrieved from the database 30 in step 1306 and the process proceeds to step 1308 where the transaction is recorded. If the transaction data retrieved in step 1302 is the latest copy then the process proceeds directly to step 1308.

Once the transaction has been recorded, then the certificates and signatures from the donor are obtained in step 1310. If a broker connection is required in step 1312, then the process continues to step 1314 where the system 10 will connect to the broker system. If the broker will update the transfer agent in step 1318, then a confirmation will be received in step 1320. However, if the broker will not update the transfer agent, then the system 10 is connected to the transfer agent in step 1316 to complete the transfer. Alternatively, if the broker connection is not required in step 1312, then the process proceeds directly to step 1316 and connects to the transfer agent. Once the transfer is complete, then the receive confirmation is issued in step 1320.

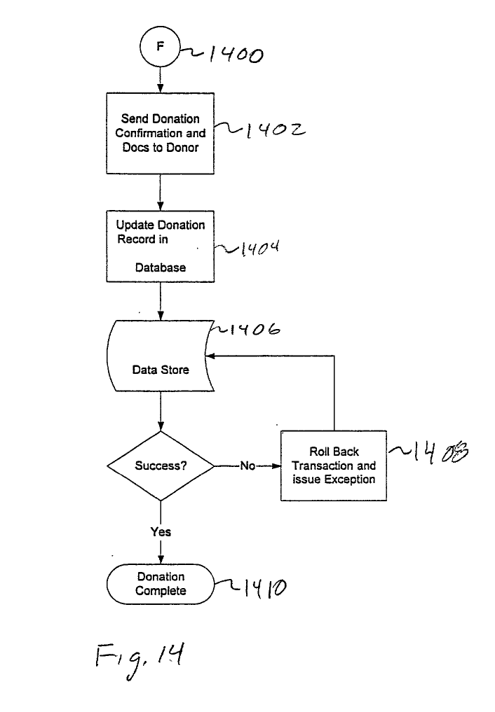

Referring to FIG. 14, once the transfer has been completed, the process proceeds to step 1402 where a donation confirmation and the necessary documents are sent to the donor. The process in step 1404 then updates the donation record in the database 30 and stores the data in step 1406. If the data is successfully stored, then the process proceeds to step 1410 where the donation is complete. Otherwise, the process proceeds to step 1408 where the process is rolled back and returned to step 1406 to store the data.

As previously described, the philanthropic system 10 provides a method of facilitating a stock transfer electronically. The system 10 is operative to complete the steps necessary to electronically facilitate the transfer of stock certificates to a charitable organization.

The philanthropic system 10 is also capable of being integrated/interfaced with other fund-raising tools and web sites. It is a marketing tool for soliciting time, money and goods by creating a personal ask from a friend which brings traffic to a desired web site. Accordingly, by integrating the philanthropic system 10 into a web site, it is possible to increase traffic because the system 10 provides a personal referral. Furthermore, the system 10 is capable of synching with and using other databases in order to generate referrals.

Additional modifications and improvements of the present invention may also be apparent to those of ordinary skill in the art such as providing for non-cash donations. Thus, the particular combination of parts described and illustrated herein is intended to represent only certain embodiments of the present invention, and is not intended to serve as limitation of alternative devices within the spirit and scope of the invention.

1. A method for soliciting donations over a network of computers, the method comprising the steps of:
a) defining the terms of a challenge;
b) generating an invitation to donate including the terms of the challenge; and
c) sending the invitation to donate to at least one invitee with a computer connected to the network of computers.

2. The method of claim 1 wherein step (a) further comprises defining the terms of the challenge with the computer connected to the network of computers.

3. The method of claim 2 wherein the terms of the challenge are defined using a web-based application.

4. The method of claim 3 wherein the terms of the challenge define an amount to be matched by a donor when an invitee donates a prescribed amount.

5. The method of claim 1 wherein step (b) comprises generating the invitation to donate as an email which is sent to the invitee and step (c) comprises sending the email to the at least one invitee.

6. The method of claim 1 wherein step (b) comprises generating the email with a web-based application.

7. The method of claim 1 further comprising the step of:
d) receiving the invitation to donate by at least one invitee; and
e) replying to the invitation to donate over the network of computers by the invitee.

8. The method of claim 7 wherein step (e) further comprises processing a donation in response to the invitation to donate with a web-based application.

9. The method of claim 1 wherein step (a) further comprises choosing an organization to donate.

10. A method of soliciting donations from referrals by a donor with a computer connected to a server running a web-based donation application, the method comprising the steps of:
a) connecting to the server with a computer of the donor;
b) defining the terms of a challenge wherein the terms include the donor matching the donations of referrals according to a prescribed rule;
c) creating an invitation to donate with the web-based donation application wherein the invitation to donate includes the terms of the challenge;
d) sending the invitation to donate to at least one referral with the web-based donation application; and
e) processing with the web-based donation application, the donations received by the referrals.

11. The method of claim 10 wherein step (c) comprises creating an email as the invitation to donate.

12. The method of claim 11 wherein step (d) comprises sending the email to donate to at least one referral.

13. The method of claim 10 wherein step (c) further comprises providing a list of referrals to the web-based donation application, the referrals to be sent the invitation to donate.

14. The method of claim 10 wherein the terms of the challenge define a rule in which the amount to be matched by a donor when a referral donates a prescribed amount is decided.

15. The method of claim 14 wherein step (b) further comprises choosing an organization to donate.

16. A method of transferring stock certificates using a web-based donation application from a donor to a recipient, the method comprising the steps of:
a) choosing a recipient for the donation with the web-based donation application;
b) determining an identity of the possessor of the certificates;
c) requesting with the web-based donation application that the possessor transfer the certificates;
d) obtaining from the possessor the stock certificates;
e) transferring the certificates to the recipient; and
f) updating the web-based donation application that the transfer was complete.

17. The method of claim 16 wherein step (a) comprises matching donation criteria using the web-based donation application in order to choose the recipient.

18. The method of claim 16 wherein step (b) comprises determining whether the donor or a broker has possession of the certificates.

19. The method of claim 18 further comprising the step of determining broker information if the broker has possession of the certificates.

20. The method of claim 16 wherein step (a) comprises determining whether the recipient is a valid recipient with the web-based donation application.
